(19) United States
(12) Patent Application Publication
(10) Pub. No.: US 2012/0026072 A1
(43) Pub. Date: Feb. 2, 2012

(54) ACTIVE DEVICE ARRAY SUBSTRATE, DISPLAY PANEL AND REPAIR METHOD

(75) Inventors: Hao-Lin Chiu, Taipei City (TW); Yih-Chyun Kao, Changhua County (TW)

(73) Assignee: AU OPTRONICS CORPORATION, Hsinchu (TW)

(21) Appl. No.: 12/898,725

(22) Filed: Oct. 6, 2010

(30) Foreign Application Priority Data
Jul. 29, 2010 (TW) 99125127

(51) Int. Cl. G09G 3/20

(52) U.S. Cl. 345/55

(57) ABSTRACT

A display panel, a repair method, and an active device array substrate including a substrate, first and second signal lines, active devices, pixel electrodes, a bus line, and a switch device are provided. The bus line and the switch device are disposed outside a display region of the active device array substrate. The switch device has a gate coupled to the bus line, a first electrode coupled to a signal source, and a second electrode coupled to one of the first signal lines. The first and second electrodes are comb-shaped. The first electrode includes first fingers parallel to one another and a first connection portion connected to the first fingers. The second electrode includes second fingers parallel to one another and a second connection portion connected to the second fingers. The first and second fingers are arranged alternately. A portion of the first electrode is located outside the gate.

### CROSS-REFERENCE TO RELATED APPLICATION

This application claims the priority benefit of Taiwan application serial no. 99125127, filed on Jul. 29, 2010. The entirety of the above-mentioned patent application is hereby incorporated by reference herein and made a part of this specification.

### BACKGROUND OF THE INVENTION

1. Field of the Invention

The invention relates to an active device array substrate, a display panel, and a repair method. More particularly, the invention relates to an active device array substrate, a display panel, and a repair method capable of reducing resistance-capacitance (RC) loading during signal transmission and preventing short circuit caused by metallic particles.

2. Description of Related Art

In normal displays, bottom gate thin film transistors (TFT) have high parasitic capacitance (C_{gd} and C_{gs}), and therefore significant RC loading is often generated during signal transmission if the bottom gate TFT serves as the TFT in a driving circuit.

In most cases, the bottom gate TFT in the driving circuit is disposed on a coating path of a sealant. Hence, when the sealant is cured by ultraviolet light, the sealant cannot be completely cured due to the metal gate in the bottom gate TFT.

Besides, in the process of forming the driving circuit (including the bottom gate TFT), metallic particles are very much likely to be formed. If the metallic particles fall between the source and the drain, then the short circuit occurs. As such, devices cannot be fully or partially operated.

### SUMMARY OF THE INVENTION

The invention is directed to an active device array substrate capable of effectively reducing RC loading when signals are transmitted by a driving circuit.

The invention is further directed to a display panel capable of resolving an issue of incompletely curing a sealant caused by a metal gate in a driving circuit.

The invention is further directed to a repair method capable of removing short circuit phenomenon caused by metallic particles falling between a source and a drain of a driving circuit.

The invention provides an active device array substrate having a display region. The active device array substrate includes a substrate, a plurality of first signal lines, a plurality of second signal lines, a plurality of active devices, a plurality of pixel electrodes, a bus line, and a switch device. The first signal lines and the second signal lines are arranged on the substrate and interlaced with each other to define a plurality of pixel regions in the display region. The active devices are respectively disposed corresponding to the pixel regions and coupled to the first signal lines and the second signal lines. The pixel electrodes are respectively disposed in the pixel regions and coupled to the active devices. The bus line is disposed outside the display region. The switch device is disposed outside the display region. Besides, the switch device has a gate, a first electrode, and a second electrode. The gate is coupled to the bus line, and the first and second electrodes are located above the gate. The first electrode is coupled to a signal source, and the second electrode is coupled to one of the first signal lines. The first and second electrodes are comb-shaped, respectively. The first electrode includes a plurality of first fingers parallel to one another and a first connection portion connecting the first fingers. The second electrode includes a plurality of second fingers parallel to one another and a second connection portion connecting the second fingers. The first fingers and the second fingers are alternately arranged, and a portion of the first electrode is located outside the gate.

According to an embodiment of the invention, the first connection portion is, for example, located outside the gate. Each of the first fingers has a first end contiguously connected to the first connection portion, and the first ends are located outside the gate.

According to an embodiment of the invention, the second connection portion is, for example, located outside the gate. Each of the second fingers has a second end contiguously connected to the second connection portion, and the second ends are located outside the gate.

According to an embodiment of the invention, a portion of the second electrode is, for example, located outside the gate.

According to an embodiment of the invention, the bus line has a plurality of slits, for instance.

According to an embodiment of the invention, the slits are arranged along an extending direction of the bus line, for instance.

According to an embodiment of the invention, the first fingers are parallel to the second fingers.

The invention further provides a display panel including an active device array substrate, an opposite substrate, and a display medium layer. The active device array substrate has a display region. Besides, the active device array substrate includes a substrate, a plurality of active devices, a plurality of pixel electrodes, a bus line, and a switch device. The active devices are disposed in the display region. The pixel electrodes are disposed in the display region and respectively coupled to the active devices. The bus line is disposed outside the display region. The switch device is disposed outside the display region. Besides, the switch device has a gate, a first electrode, and a second electrode. The gate is coupled to the bus line, and the first and second electrodes are located above the gate. The first electrode is coupled to a signal source, and the second electrode is coupled to one of the active devices. The first and second electrodes are comb-shaped, respectively. The first electrode includes a plurality of first fingers parallel to one another and a first connection portion connecting the first fingers. The second electrode includes a plurality of second fingers parallel to one another and a second connection portion connecting the second fingers. The first fingers and the second fingers are alternately arranged, and a portion of the first electrode is located outside the gate. The opposite substrate is disposed opposite to the active device array substrate. The display medium layer is disposed between the active device array substrate and the opposite substrate.

According to an embodiment of the invention, the first connection portion is, for example, located outside the gate. Each of the first fingers has a first end contiguously connected to the first connection portion, and the first ends are located outside the gate.

According to an embodiment of the invention, the second connection portion is, for example, located outside the gate. Each of the second fingers has a second end contiguously connected to the second connection portion, and the second ends are located outside the gate.

According to an embodiment of the invention, a portion of the second electrode is, for example, located outside the gate.

According to an embodiment of the invention, the bus line has a plurality of slits, for instance.

According to an embodiment of the invention, the display panel further includes a sealant. At least one portion of the sealant is disposed on the bus line and located between the active device array substrate and the opposite substrate.

According to an embodiment of the invention, the slits are arranged along an extending direction of the bus line, for instance.

According to an embodiment of the invention, the first fingers are parallel to the second fingers.

The invention further provides a repair method for repairing an active device array substrate or a display panel having the active device array substrate. The active device array substrate has a display region. Besides, the active device array substrate includes a substrate, a plurality of first signal lines, a plurality of second signal lines, a plurality of active devices, a plurality of pixel electrodes, a bus line, and a switch device. The first signal lines and the second signal lines are arranged on the substrate and interlaced with each other to define a plurality of pixel regions in the display region. The active devices are respectively disposed corresponding to the pixel regions and coupled to the first signal lines and the second signal lines. The pixel electrodes are respectively disposed in the pixel regions and coupled to the active devices. The bus line is disposed outside the display region. The switch device is disposed outside the display region. Besides, the switch device has a gate, a first electrode, and a second electrode. The gate is coupled to the bus line, and the first and second electrodes are located above the gate. The first electrode is coupled to a signal source, and the second electrode is coupled to one of the first signal lines. The first and second electrodes are comb-shaped, respectively. The first electrode includes a plurality of first fingers parallel to one another and a first connection portion connecting the first fingers. The second electrode includes a plurality of second fingers parallel to one another and a second connection portion connecting the second fingers. The first fingers and the second fingers are alternately arranged. The first connection portion is located outside the gate. Each of the first fingers has a first end contiguously connected to the first connection portion, and the first ends are located outside the gate. In the repair method, when short circuit occurs between one of the first fingers and a corresponding one of the second fingers, the first end of the first finger encountering the short circuit is cut, such that the rest of the first finger encountering the short circuit is electrically insulated from the first connection portion and the other first fingers.

According to an embodiment of the invention, the second connection portion is located outside the gate, for example. Each of the second fingers has a second end contiguously connected to the second connection portion, and the second ends are located outside the gate. When the short circuit occurs between one of the first fingers and the corresponding one of the second fingers, the second end of the second finger encountering the short circuit is cut, such that the rest of the second finger encountering the short circuit is electrically insulated from the second connection portion and the other second fingers.

Based on the above, the first electrode and the second electrode of the switch device are comb-shaped in the invention. Besides, the first fingers of the first electrode and the second fingers of the second electrode are alternately arranged, such that the switch device of the driving circuit is considered to be constituted by a plurality of small TFTs connected in parallel. Therefore, when the metallic particles fall between the first and second electrodes and the short circuit occurs, the first end of the first finger and/or the second end of the second finger that encounters the short circuit can be cut to resolve the short circuit issue.

In addition, according to this invention, the bus line has a plurality of slits, and therefore RC loading between switch pulse (SW pulse) signals and other data signals can be mitigated effectively.

Moreover, since the bus line of the invention has a plurality of slits, the sealant can be cured by ultraviolet light passing through the slits. As such, the bus line and the switch device no longer make a great impact on curing the sealant, and the issue of incompletely curing the sealant can be resolved.

It is to be understood that both the foregoing general descriptions and the following detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention.

FIG. 1 is a schematic diagram illustrating circuits in an active device array substrate according to an embodiment of the invention.

FIG. 2 is a schematic top view illustrating a bus line and a switch device depicted in FIG. 1.

FIG. 3 is a schematic diagram illustrating circuits in the switch device depicted in FIG. 2.

FIG. 4 is a schematic cross-sectional view illustrating a display panel according to an embodiment of the invention.

FIG. 5 is a schematic top view of repairing the switch device depicted in FIG. 2.

FIG. 6 is a schematic diagram of repairing circuits in the switch device depicted in FIG. 2.

FIG. 7 is a schematic diagram illustrating circuits in an active device array substrate according to another embodiment of the invention.

### DESCRIPTION OF EMBODIMENTS

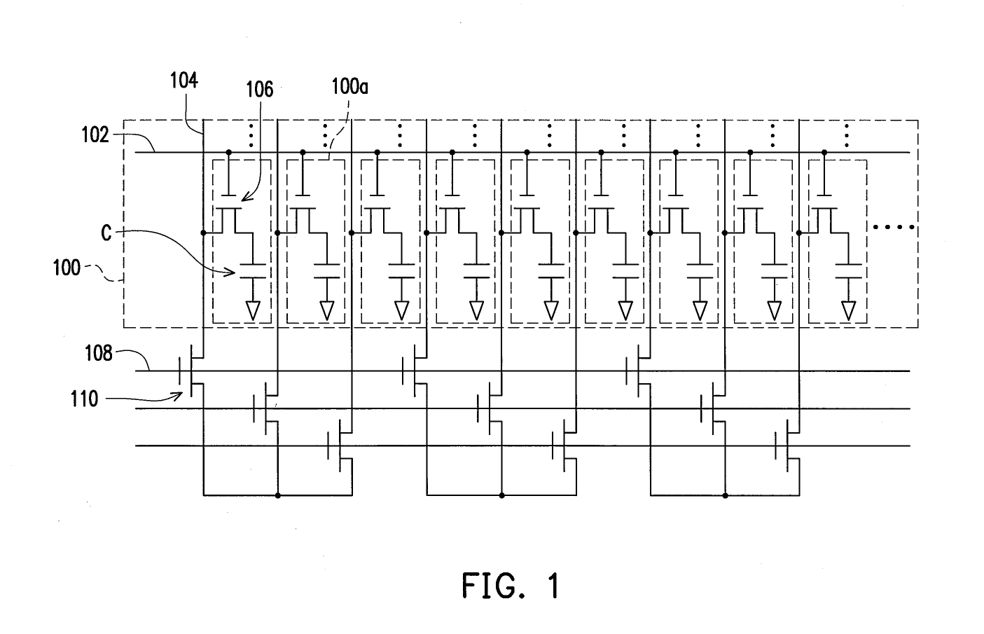

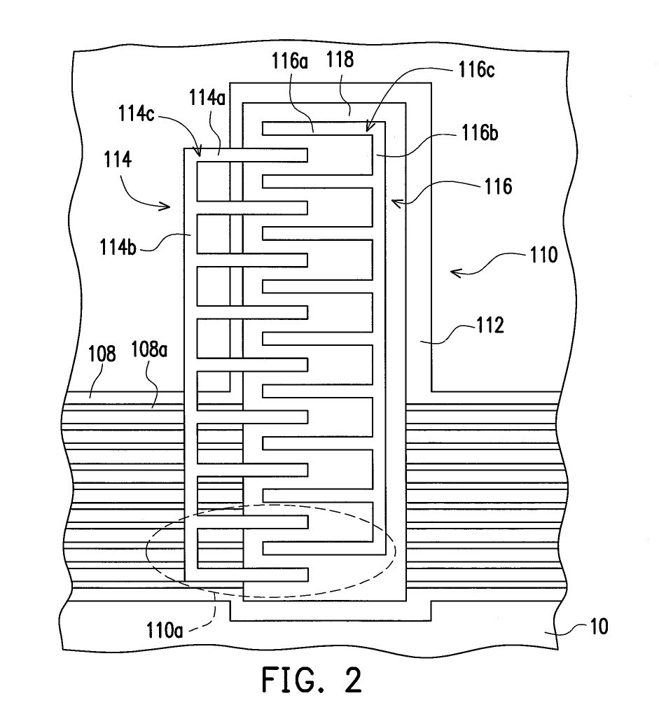

FIG. 1 is a schematic diagram illustrating circuits in an active device array substrate according to an embodiment of the invention. For illustrative and descriptive purposes, only one scan line is depicted in FIG. 1, while there are actually a plurality of scan lines in the active device array substrate. As indicated in FIG. 1, the active device array substrate has a display region 100. Besides, the active device array substrate includes a substrate, first signal lines, second signal lines, active devices 106, pixel electrodes (not shown), a bus line 108, and a switch device 110. The substrate is depicted in FIG. 2 and will be described later. In this embodiment, the first signal lines are scan lines 102, and the second signal lines are data lines 104.

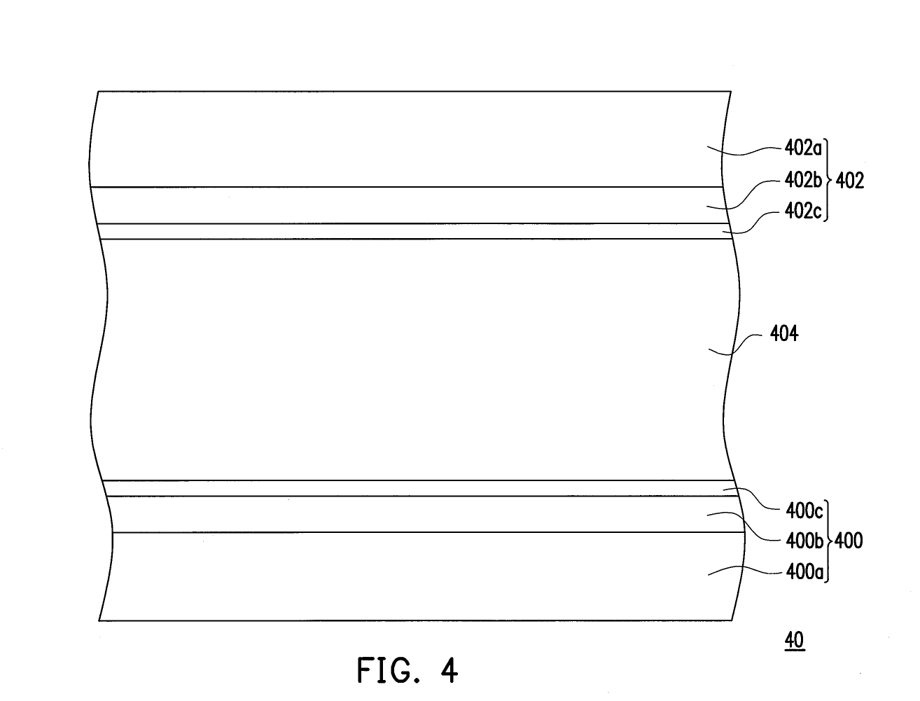

The scan lines 102 and the data lines 104 are arranged on the substrate and interlaced with each other to define a plurality of pixel regions 100a in the display region 100. The active devices 106 are disposed corresponding to the pixel regions 100a and coupled to the scan lines 102 and the data lines 104. The pixel electrodes are respectively disposed in the pixel regions 100a and coupled to the active devices 106. To be more specific, the active devices 106 are the well-known TFTs, for instance. The gates of the TFTs are coupled to the scan lines 102. The sources of the TFTs are coupled to the data lines 104. The drains of the TFTs are coupled to the pixel electrodes. In addition, the pixel electrodes in the active device array substrate, the common electrode in the opposite substrate, and the display medium layer sandwiched between the active device array substrate and the opposite substrate together form the capacitor C. The opposite substrate and the display medium layer are described later with reference to FIG. 4.

The bus line 108 and the switch device 110 are disposed outside the display region 100. Here, the bus line 108 and the switch device 110 together form the driving circuit for driving the active devices 106. In FIG. 1, three bus lines 108 are depicted, which should not be construed as a limitation to this invention.

The bus line 108 and the switch device 110 are elaborated hereinafter with reference to FIG. 2.

FIG. 2 is a schematic top view illustrating the bus line and the switch device depicted in FIG. 1. As indicated in FIG. 2, the switch device 110 is disposed on the substrate 10. The substrate 10 is, for example, a glass substrate. The switch device 110 has a gate 112, a first electrode 114, and a second electrode 116. The gate 112 is coupled to the bus line 108. In this embodiment, the gate 112 and the bus line 108 are in the same metal layer. The first electrode 114 and the second electrode 116 respectively acting as the source and the drain are located above the gate 112. In an alternative embodiment, the first electrode 114 and the second electrode 116 can also serve as the drain and the source, respectively. An active layer 118 acting as a channel is located between the gate 112 and the first and second electrodes 114 and 116. The first electrode 114 is coupled to an external signal source (not shown), and the second electrode 116 is coupled to the data lines 104.

The first and second electrodes 114 and 116 are comb-shaped, respectively. In particular, the first electrode 114 includes first fingers 114a parallel to one another and a first connection portion 114b connected to the first fingers 114a. The second electrode 116 includes second fingers 116a parallel to one another and a second connection portion 116b connected to the second fingers 116a. The first fingers 114a and the second fingers 116a are alternately arranged. In this embodiment, the first fingers 114a are, for instance, parallel to the second fingers 116a, and a portion of the first electrode 114 is located outside the gate 112. Namely, the projection of the first electrode 114 on the substrate 10 is partially located outside the projection of the gate 112 on the substrate 10. In detail, the first connection portion 114b is located outside the gate 112. Additionally, each of the first fingers 114a has a first end 114c contiguously connected to the first connection portion 114b, and the first ends 114c are located outside the gate 112.

In this embodiment, the first ends 114c and the first connection portion 114b of the first electrode 114 are located outside the gate 112, and the second ends 116c and the second connection portion 116b of the second electrode 116 are located above the gate 112. However, in other embodiments of the invention, the second connection portion 116b of the second electrode 116 and the second ends 116c (contiguously connected to the second connection portion 116b) of the second fingers 116a can be located outside the gate 112, while the first ends 114c and the first connection portion 114b of the first electrode 114 are located above the gate 112. Alternatively, the first connection portion 114b of the first electrode 114, the first ends 114c, the second connection portion 116b of the second electrode 116, and the second ends 116c are all located outside the gate 112.

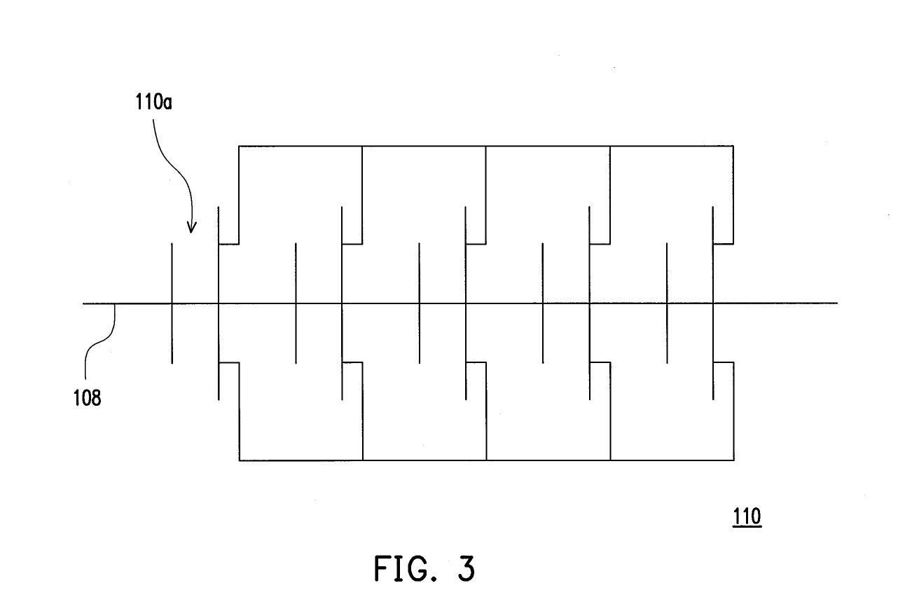

In this embodiment, the first and second electrodes 114 and 116 are comb-shaped, respectively, and the first fingers 114a of the first electrode 114 and the second fingers 116a of the second electrode 116 are alternately arranged. Hence, the switch device 110 of the driving circuit can be deemed as a plurality of small TFTs 110a connected in parallel. FIG. 3 is a schematic diagram illustrating circuits in the switch device depicted in FIG. 2. As indicated in FIG. 3, the TFTs 110a are connected in parallel, so as to form the switch device 110, and the gates of the TFTs 110a, i.e. a portion of the gate 112, are coupled to the bus line 108.

Besides, the bus line 108 in this embodiment has a plurality of slits 108a. The slits 108a are arranged along an extending direction of the bus line 108, for instance. Since the bus line 108 has the slits 108a, RC loading between SW pulse signals and other data signals can be effectively reduced. In other words, the bus line 108 having the slits 108a mitigates the RC loading during signal transmission.

Furthermore, the bus line 108 has the slits 108a. Hence, even though the bus line 108 and the switch device 110 are located on the coating path of the sealant, the sealant can be cured by ultraviolet light passing through the slits 108a. As such, the bus line 108 and the switch device 110 make the least impact on curing the sealant, and the issue of incompletely curing the sealant can be resolved.

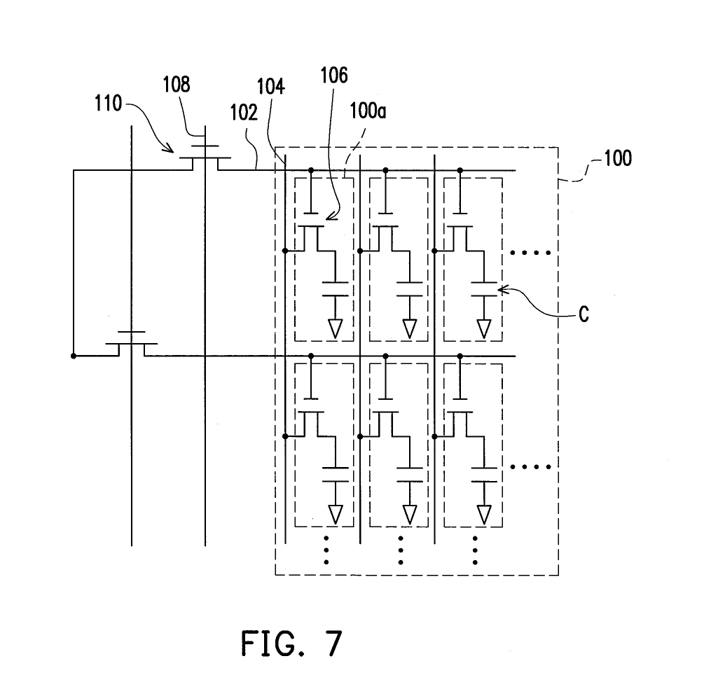

According to the previous embodiment, the second electrode 116 of the switch device 110 is coupled to the data lines 104. The second electrode 116 of the switch device 110 can also be coupled to the scan lines 102 in another embodiment of the invention, as indicated in FIG. 7.

A display panel having the active device array substrate depicted in FIG. 1 is discussed below.

FIG. 4 is a schematic cross-sectional view illustrating a display panel according to an embodiment of the invention. As shown in FIG. 4, the display panel 40 includes an active device array substrate 400, an opposite substrate 402, and a display medium layer 404. The active device array substrate 400 is identical to the active device array substrate depicted in FIG. 1. The active device array substrate 400 includes a substrate 400a, an active device layer 400b located on the substrate 400a, and pixel electrodes 400c located on the active device layer 400b. The substrate 400a is, for example, a glass substrate. Besides, the bus line 108 and the switch device 110 as shown in FIG. 1, FIG. 2, and FIG. 3 are located on the substrate 400a. The active device layer 400b includes the scan lines 102, the data lines 104, and the active devices 106 as indicated in FIG. 1, FIG. 2, and FIG. 3. The opposite substrate 402 is disposed opposite to the active device array substrate 400. Besides, the opposite substrate 402 is, for example, a color filter substrate and includes a substrate 402a, a color filter layer 402b located on the substrate 402a, and a common electrode 402c located on the color filter layer 402b. The substrate 402a is, for example, a glass substrate. The display medium layer 404 is disposed between the opposite substrate 402 and the active device array substrate 400. Here, the display medium layer 404 is, for instance, a liquid crystal layer, a plasma layer, an electro-phoretic display layer, or an organic light emitting device layer. The display panel 40 having the different display medium layer 404 can also be in different types, e.g. a liquid crystal display panel, a plasma display panel, an electro-phoretic display panel, or an organic light emitting display panel.

It should be mentioned that metallic particles are apt to be formed during fabrication of the driving circuit (including the bus line 108 and the switch device 110), and the metallic particles result in short circuit when falling between the source and the drain (i.e. the first electrode 114 and the second electrode 116). To resolve the short circuit issue, the first electrode 114 and the second electrode 116 need to be repaired.

The repair method of this invention is described hereinafter by taking the switch device of FIG. 2 as an example.

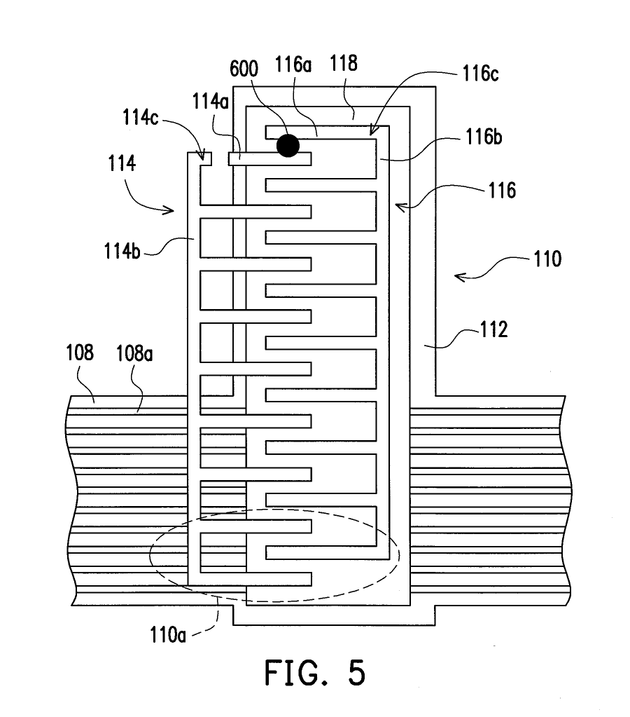

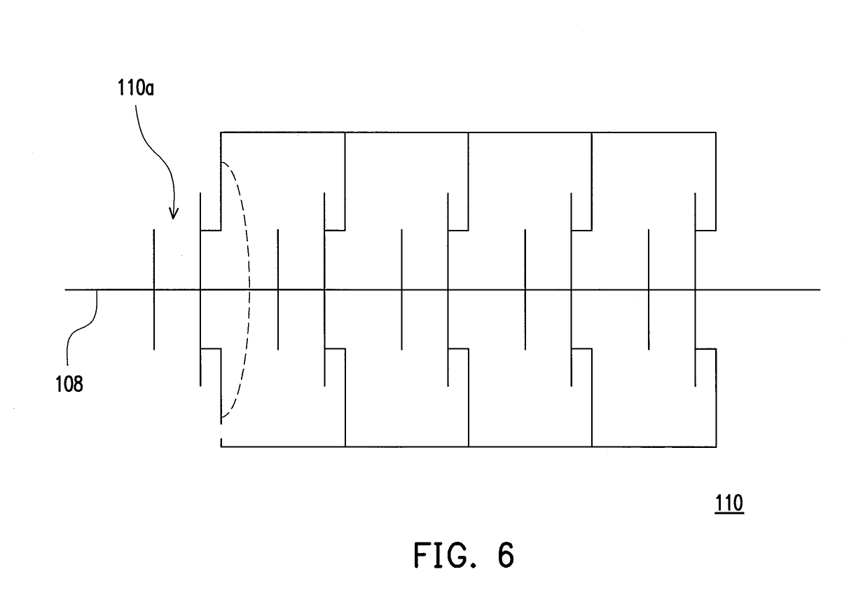

FIG. 5 is a schematic top view of repairing the switch device depicted in FIG. 2. FIG. 6 is a schematic diagram of repairing circuits in the switch device depicted in FIG. 2. With reference to FIG. 5 and FIG. 6, when the metallic particles fall between the first and second electrodes 114 and 116, short circuit occurs. In this embodiment, the metallic particles 600 fall between one of the first fingers 114a and a corresponding one of the second fingers 116a, and therefore short circuit arises between the first and second electrodes 114 and 116. At this time, the first end 114c of the first finger 114a encountering the short circuit is cut, such that the first finger 114a having the metallic particles 600 is separated (i.e. electrically insulated) from the first connection portion 114b and the other first fingers 114a. Thereby, the short circuit issue between the first and second electrodes 114 and 116 can be resolved. The first end 114c is cut by performing a laser cutting process, for instance.

In this embodiment, metallic particles 600 are only located in one place between the first and second electrodes 114 and 116, and thus only one first end 114c needs to be cut. However, in other embodiments of the invention, if the metallic particles 600 are in more than one places between the first and second electrodes 114 and 116, the first ends 114c corresponding to the metallic particles 600 should be cut.

In another embodiment of the invention, if the second connection portion 116b of the second electrode 116 and the second ends 116c are located outside the gate 112, and if the metallic particles 600 result in short circuit when falling between the first and second electrodes 114 and 116, the second ends 116c are cut, such that the second fingers 116a having the metallic particles 600 are separated from the second connection portion 116b and the other second fingers 116a.

In still another embodiment of the invention, if the first connection portion 114b of the first electrode 114, the first ends 114c, the second connection portion 116b of the second electrode 116, and the second ends 116c are all located outside the gate 112, and if the metallic particles 600 result in short circuit when falling between the first and second electrodes 114 and 116, the first ends 114c, the second ends 116c, or both the first and second ends 114c and 116c can be cut.

That is to say, the switch device 110 is deemed to be formed by a plurality of small TFTs 110a connected in parallel in the above-mentioned repair process. Accordingly, when one of the TFTs 110a encounters short circuit, the TFT 110a encountering the short circuit is electrically insulated from the other TFTs 110a through performing the cutting process. Thereby, the short circuit issue can be resolved, and the other TFTs 110a can continue to operate.

It will be apparent to those skilled in the art that various modifications and variations can be made to the structure of the present invention without departing from the scope or spirit of the present invention. In view of the foregoing, it is intended that the present invention cover modifications and variations of the present invention provided they fall within the scope of the following claims and their equivalents.

What is claimed is:

1. An active device array substrate having a display region and comprising:
a substrate;
a plurality of first signal lines and a plurality of second signal lines, the first signal lines and second signal lines being arranged on the substrate and interlaced with each other to define a plurality of pixel regions in the display region;
a plurality of active devices respectively disposed corresponding to the pixel regions and coupled to the first signal lines and the second signal lines;
a plurality of pixel electrodes respectively disposed in the pixel regions and coupled to the active devices;
a bus line disposed outside the display region; and
a switch device disposed outside the display region and having a gate, a first electrode, and a second electrode, the gate being coupled to the bus line, the first electrode and the second electrode being located above the gate, the first electrode being coupled to a signal source, the second electrode being coupled to one of the first signal lines, the first electrode and the second electrode being comb-shaped, the first electrode comprising a plurality of first fingers parallel to one another and a first connection portion connected to the first fingers, the second electrode comprising a plurality of second fingers parallel to one another and a second connection portion connected to the second fingers, wherein the first fingers and the second fingers are alternately arranged, and a portion of the first electrode is located outside the gate.

2. The active device array substrate as claimed in claim 1, wherein the first connection portion is located outside the gate, each of the first fingers has a first end contiguously connected to the first connection portion, and the first ends are located outside the gate.

3. The active device array substrate as claimed in claim 2, wherein the second connection portion is located outside the gate, each of the second fingers has a second end contiguously connected to the second connection portion, and the second ends are located outside the gate.

4. The active device array substrate as claimed in claim 1, wherein a portion of the second electrode is located outside the gate.

5. The active device array substrate as claimed in claim 1, wherein the bus line has a plurality of slits.

6. The active device array substrate as claimed in claim 5, wherein the slits are arranged along an extending direction of the bus line.

7. The active device array substrate as claimed in claim 1, wherein the first fingers are parallel to the second fingers.

8. A display panel comprising:
an active device array substrate having a display region and comprising:
a substrate;
a plurality of active devices disposed in the display region;
a plurality of pixel electrodes disposed in the display region and respectively coupled to the active devices;
a bus line disposed outside the display region; and
a switch device disposed outside the display region and having a gate, a first electrode, and a second electrode, the gate being coupled to the bus line, the first electrode and the second electrode being located above the gate, the first electrode being coupled to a signal source, the second electrode being coupled to one of the active devices, the first electrode and the second electrode being comb-shaped, the first electrode comprising a plurality of first fingers parallel to one another and a first connection portion connected to the first fingers, the second electrode comprising a plurality of second fingers parallel to one another and a second connection portion connected to the second fingers, wherein the first fingers and the second fingers are alternately arranged, and a portion of the first electrode is located outside the gate;
an opposite substrate disposed opposite to the active device array substrate; and
a display medium layer disposed between the active device array substrate and the opposite substrate.

9. The display panel as claimed in claim 8, wherein the first connection portion is located outside the gate, each of the first fingers has a first end contiguously connected to the first connection portion, and the first ends are located outside the gate.

10. The display panel as claimed in claim 9, wherein the second connection portion is located outside the gate, each of the second fingers has a second end contiguously connected to the second connection portion, and the second ends are located outside the gate.

11. The display panel as claimed in claim 8, wherein a portion of the second electrode is located outside the gate.

12. The display panel as claimed in claim 8, wherein the bus line has a plurality of slits.

13. The display panel as claimed in claim 12, further comprising a sealant, wherein at least one portion of the sealant is disposed on the bus line and located between the active device array substrate and the opposite substrate.

14. The display panel as claimed in claim 12, wherein the slits are arranged along an extending direction of the bus line.

15. The display panel as claimed in claim 8, wherein the first fingers are parallel to the second fingers.

16. A repair method for repairing an active device array substrate or a display panel having the active device array substrate, the active device array substrate having a display region and comprising:
a substrate;
a plurality of first signal lines and a plurality of second signal lines, the first signal lines and second signal lines being arranged on the substrate and interlaced with each other to define a plurality of pixel regions in the display region;
a plurality of active devices respectively disposed corresponding to the pixel regions and coupled to the first signal lines and the second signal lines;
a plurality of pixel electrodes respectively disposed in the pixel regions and coupled to the active devices;
a bus line disposed outside the display region;
a switch device disposed outside the display region and having a gate, a first electrode, and a second electrode, the gate being coupled to the bus line, the first electrode and the second electrode being located above the gate, the first electrode being coupled to a signal source, the second electrode being coupled to one of the first signal lines, the first electrode and the second electrode being comb-shaped, the first electrode comprising a plurality of first fingers parallel to one another and a first connection portion connected to the first fingers, the second electrode comprising a plurality of second fingers parallel to one another and a second connection portion connected to the second fingers, wherein the first fingers and the second fingers are alternately arranged, the first connection portion is located outside the gate, each of the first fingers has a first end contiguously connected to the first connection portion, and the first ends are located outside the gate;
the repair method comprising:
when short circuit occurs between one of the first fingers and a corresponding one of the second fingers, cutting the first end of the first finger encountering the short circuit, such that the rest of the first finger encountering the short circuit is electrically insulated from the first connection portion and the other first fingers.

17. The repair method as claimed in claim 16, wherein the second connection portion being located outside the gate, each of the second fingers having a second end contiguously connected to the second connection portion, the second ends being located outside the gate, wherein when the short circuit occurs between one of the first fingers and the corresponding one of the second fingers, the repair method further comprises:
cutting the second end of the second finger encountering the short circuit, such that the rest of the second finger encountering the short circuit is electrically insulated from the second connection portion and the other second fingers.
